(19) United States
(12) Patent Application Publication
(10) Pub. No.: US 2017/0289071 A1
(43) Pub. Date: Oct. 5, 2017

(54) SYSTEM, APPARATUS AND METHOD FOR AUTONOMOUS MESSAGING INTEGRATION

(71) Applicant: KIK INTERACTIVE INC., Waterloo (CA)

(72) Inventors: Michael ROBERTS, Waterloo (CA); Laura NEWTON, Waterloo (CA)

(21) Appl. No.: 15/474,526

(22) Filed: Mar. 30, 2017

Related U.S. Application Data
(60) Provisional application No. 62/317,821, filed on Apr. 4, 2016.

(51) Int. Cl. H04L 12/58; H04L 29/06

(52) U.S. Cl. CPC H04L 51/02; H04L 67/42; H04L 51/16; H04L 51/18

(57) ABSTRACT

A method of autonomous messaging integration at a computing device executing a primary autonomous messaging application includes: receiving a message from a client device; responsive to receiving the message, obtaining response data corresponding to the message; determining whether the message corresponds to an integration identifier stored in the memory, the integration identifier identifying a second computing device executing a secondary autonomous messaging application; when the determination is affirmative: generating integration data including the integration identifier; and sending a reply containing (i) the response data, (ii) a destination identifier corresponding to the client device, instructing a routing server to transmit the reply to the client device, and (iii) the integration data, instructing the routing server to transmit the reply to the second computing device.

### CROSS-REFERENCE TO RELATED APPLICATIONS

This application claims priority from U.S. provisional patent application No. 62/317,821, filed Apr. 4, 2016, the contents of which is incorporated herein by reference.

### FIELD

The specification relates generally to messaging systems, and specifically to a system, apparatus and method for autonomous messaging integration.

### BACKGROUND

Computing devices executing autonomous messaging applications, also referred to as chatter bots, or chatbots, have grown in popularity. Many such chatbots are, rather than general-purpose chatbots, directed to providing specific services to users, or responding to certain types (e.g. certain topics) of messages from users. As the functionality offered by chatbots expands and diversifies, combinations of such functionality may be desired. Current systems do not adequately provide for such combinations to be delivered to messaging clients.

### BRIEF DESCRIPTIONS OF THE DRAWINGS

Embodiments are described with reference to the following figures, in which:

FIG. 1 depicts a communications system, according to a non-limiting embodiment;

FIG. 2 depicts certain internal components of the messaging server, chatbot server and client device of the system of FIG. 1, according to a non-limiting embodiment;

FIG. 3 depicts a method of autonomous messaging integration, according to a non-limiting embodiment;

FIGS. 4A and 4B depict a messaging interface at the client device of FIG. 1 during the performance of FIG. 3, according to a non-limiting embodiment;

FIG. 5 depicts messages sent at block 325 of the method of FIG. 3, according to a non-limiting embodiment;

FIG. 6 depicts a method of autonomous messaging integration, according to a non-limiting embodiment;

FIG. 7 depicts messages sent at block 625 of the method of FIG. 6, according to a non-limiting embodiment;

FIG. 8 depicts a messaging interface at the client device of FIG. 1 during the performance of FIG. 6, according to a non-limiting embodiment;

FIGS. 9A and 9B depict a messaging interface at the client device of FIG. 1 during the performance of FIG. 3, according to another non-limiting embodiment; and

FIGS. 10A and 10B depict a messaging interface at the client device of FIG. 1 during the performance of FIG. 6, according to another non-limiting embodiment.

### DETAILED DESCRIPTION OF THE EMBODIMENTS

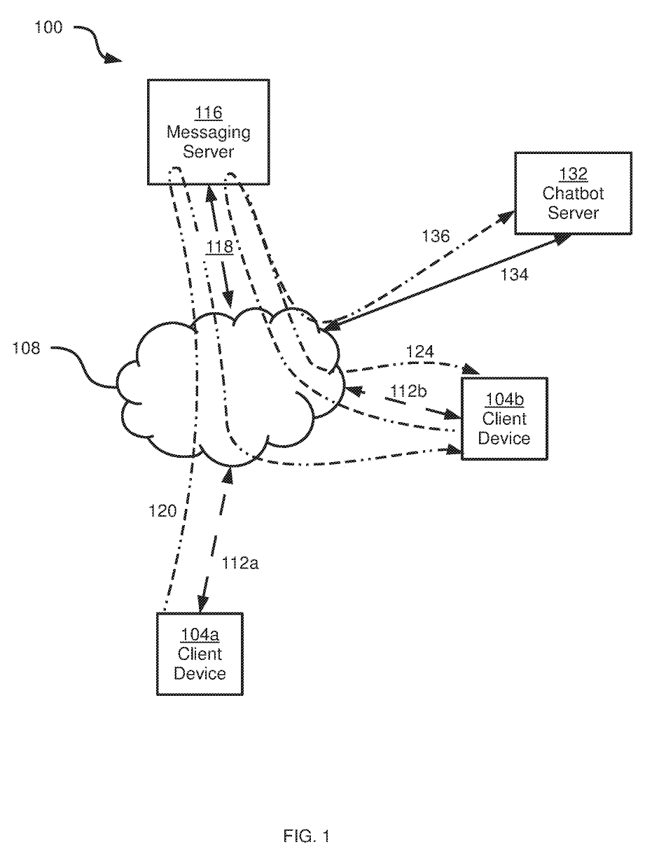

FIG. 1 depicts a communications system 100. System 100 includes a plurality of client computing devices, of which two examples 104a and 104b are shown (referred to generically as a client computing device 104 or a client device 104, and collectively as client computing devices 104 or client devices 104). Additional client computing devices (not shown) can be included in system 100. Each client computing device 104 can be any of a cellular phone, a smart phone, a tablet computer, a wearable device such as a smart watch or smart glasses, and the like.

Client computing devices 104a and 104b are connected to a network 108 via respective links 112a and 112b, which are illustrated as wireless links but can also be wired links, or any suitable combination of wired and wireless links. Network 108 can include any suitable combination of wired and wireless networks, including but not limited to a Wide Area Network (WAN) such as the Internet, a Local Area Network (LAN) such as a corporate data network, cell phone networks, WiFi networks and the like.

Via network 108, client computing devices 104 can communicate with a messaging server 116 connected to network 108 via a link 118. Messaging server 116 provides a messaging service to client computing devices 104. For example, client computing device 104a can execute a messaging application for sending and receiving messages to and from messaging server 116. In the embodiments discussed herein, the messages sent and received by devices 104 are instant messages (IM, e.g. Internet Protocol-based messages utilizing a form of the XMPP protocol or the like). In other embodiments, the messages can include any suitable combination of IM, Short Message Service (SMS) messages, Multimedia Messaging Service (MMS) messages and the like.

Messaging server 116 stores associations between messaging service subscriber identifiers (e.g. account names) and identifiers of client computing devices 104 such as IP addresses, MAC addresses and the like. Messaging server 116 can therefore receive a message from a device 104 (e.g. a message sent from device 104a and addressed to the subscriber identifier associated with device 104b), look up the device identifier of the addressee (e.g. device 104b) based on the subscriber identifier contained in the message, and route the message via network 108 to the addressee (e.g. device 104b), as shown by a message path 120. As will be discussed below in greater detail, messaging server 116 can also route certain messages to other servers, or internally for further processing at server 116 itself.

Messaging server 116 is also configured to respond to certain messages autonomously. In other words, messaging server 116 can be configured to operate as a chatbot by automatically responding to messages received from client computing devices 104. For example, as shown in FIG. 1 by a message path 124, device 104b transmits a message to messaging server 116 and messaging server 116 generates and returns a response to device 104b via network 108. In system 100, chatbots can be relatively simple systems providing predetermined responses to identified messages, or categories of messages, or can be sophisticated artificial intelligence systems employing natural language processing and/or deep learning techniques.

System 100 can include a plurality of chatbots, implemented within server 116 or externally to server 116. In the present example, in addition to the chatbot implemented at server 116, system 100 also includes a chatbot server 132 connected to network 108 via a link 134 (a wired link, in the present embodiment).

In addition to the functionality mentioned above, messaging server 116 is configured to respond autonomously to certain messages from client devices 104 by causing replies to be sent not only to the originating client device 104, but also to chatbot server 132. For example, the message from client device 104b described above leads to not only the response transmitted via path 124, but also to transmission of the response to server 132 via path 136.

The selective transmission of autonomous responses to both client devices and other chatbots permits server 116 (or, indeed, any other server implementing a chatbot) to augment its own chatbot functionality with the functionality of another chatbot. That is, server 116 may be configured to respond to certain message topics in greater detail than others, to permit client devices 104 to access various external services, and the like. Server 132, on the other hand, may be configured to respond to different message topics than server 116, or to permit client devices 104 to access different external services. By automatically calling server 132 based on messages received from client devices 104, messaging server 116 effectively integrates the functionality of the chatbots at servers 116 and 132 from the perspective of the originating client device 104 (without that client device 104 being required to proactively contact both chatbots).

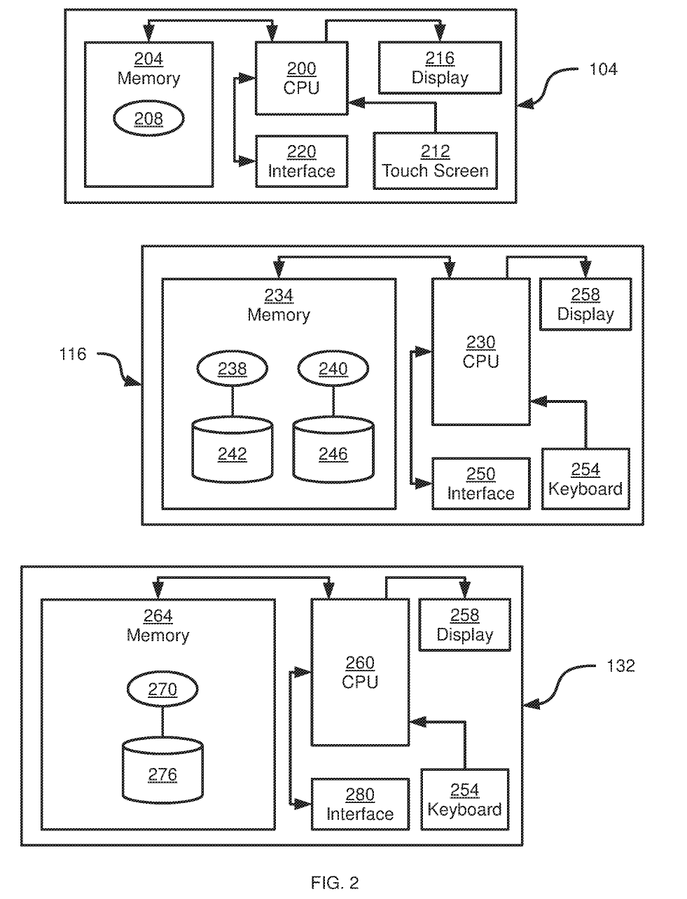

Before a detailed discussion of the operation of system 100 is provided, certain components of a client computing device 104 (which, as noted earlier, refers generically to any of devices 104a and 104b) and servers 116 and 132 will be described with reference to FIG. 2.

Referring now to FIG. 2, client computing device 104 includes a central processing unit (CPU) 200, also referred to herein as processor 200, interconnected with a memory 204. Memory 204 stores computer readable instructions executable by processor 200, including a messaging application 208. Processor 200 and memory 204 are generally comprised of one or more integrated circuits (ICs), and can have a variety of structures, as will now occur to those skilled in the art (for example, more than one CPU can be provided). Processor 200 executes the instructions of messaging application 208 to perform, in conjunction with the other components of client computing device 104, various functions related to exchanging messages with messaging server 116.

Client computing device 104 also includes input devices interconnected with processor 200, in the form of a touch screen 212. Client computing device 104 can also include other input devices, such as any suitable combination of a camera, a microphone, NFC receiver, RFID transceiver, a GPS receiver, a beacon and the like (not shown). Client computing device 104 also includes output devices interconnected with processor 200, including a display 216 integrated with touch screen 212. Other output devices can also be provided, such as a speaker (not shown). Client computing device 104 also includes a network interface 220 interconnected with processor 200, which allows client computing device 104 to connect to network 108 via a link 112 (e.g. link 112a, for device 104a). Network interface 220 thus includes the necessary hardware, such as radio transmitter/receiver units, network interface controllers and the like, to communicate over a link 112.

Messaging server 116 includes a central processing unit (CPU) 230, also referred to herein as processor 230, interconnected with a memory 234. Memory 234 stores computer readable instructions executable by processor 230, including a routing application 238 and a primary autonomous messaging (i.e. chatbot) application 240. Processor 230 and memory 234 are generally comprised of one or more integrated circuits (ICs), and can have a variety of structures, as will now occur to those skilled in the art (for example, more than one CPU can be provided). Processor 230 executes the instructions of applications 238 and 240 to perform, in conjunction with the other components of messaging server 116, various functions related to receiving and responding to messages from client computing devices 104. In the discussion below of those functions, messaging server 116 is said to be configured to perform those functions—it will be understood that messaging server 116 is so configured via the processing of the instructions in applications 238 and 240 by the hardware components of messaging server 116 (including processor 230 and memory 234).

Memory 234 also stores a routing database 242, which contains messaging account identifiers and corresponding device identifiers (e.g. IP addresses and the like) to enable server 116 to route messages to client devices 104, server 132, and application 240 within server 116, via the execution of application 238. Also stored in memory 234 is a chatbot database 246, which contains data employed by server 116—via execution of application 240—to respond autonomously to messages from client devices 104, as well as data defining actions taken by server 116 in response to messages received from client devices 104, including the above-mentioned integration of functionality provided by different chatbot applications.

Messaging server 116 also includes a network interface 250 interconnected with processor 230, which allows messaging server 116 to connect to network 108 via link 118. Network interface 250 thus includes the necessary hardware, such as network interface controllers and the like, to communicate over link 118. Messaging server 116 also includes input devices interconnected with processor 230, such as a keyboard 254, as well as output devices interconnected with processor 230, such as a display 258. Other input and output devices (e.g. a mouse, speakers) can also be connected to processor 230. In some embodiments (not shown), keyboard 254 and display 258 can be connected to processor 230 via network 108 and another computing device. In other words, keyboard 254 and display 258 can be local (as shown in FIG. 2) or remote.

Chatbot server 132 includes a central processing unit (CPU) 260, also referred to herein as processor 260, interconnected with a memory 264. Memory 264 stores computer readable instructions executable by processor 260, including a secondary autonomous messaging (i.e. chatbot) application 270. Processor 260 and memory 264 are generally comprised of one or more integrated circuits (ICs), and can have a variety of structures, as will now occur to those skilled in the art (for example, more than one CPU can be provided). Processor 260 executes the instructions of application 270 to perform, in conjunction with the other components of server 132, various functions related to receiving and responding to messages from client computing devices 104. In the discussion below of those functions, server 132 is said to be configured to perform those functions—it will be understood that server 132 is so configured via the processing of the instructions in application 270 by the hardware components of server 132 (including processor 260 and memory 264).

Memory 264 also stores a chatbot database 276, which contains data employed by server 132 to respond autonomously to messages from other computing devices, such as client devices 104.

Server 132 also includes a network interface 280 interconnected with processor 260, which allows server 132 to connect to network 108 via link 134. Network interface 280 thus includes the necessary hardware, such as network interface controllers and the like, to communicate over link 134. Server 132 also includes input devices interconnected with processor 260, such as a keyboard 284, as well as output devices interconnected with processor 260, such as a display 288. Other input and output devices (e.g. a mouse, speakers) can also be connected to processor 260. In some embodiments (not shown), keyboard 284 and display 288 can be connected to processor 260 via network 108 and another computing device. In other words, keyboard 284 and display 288 can be local (as shown in FIG. 2) or remote.

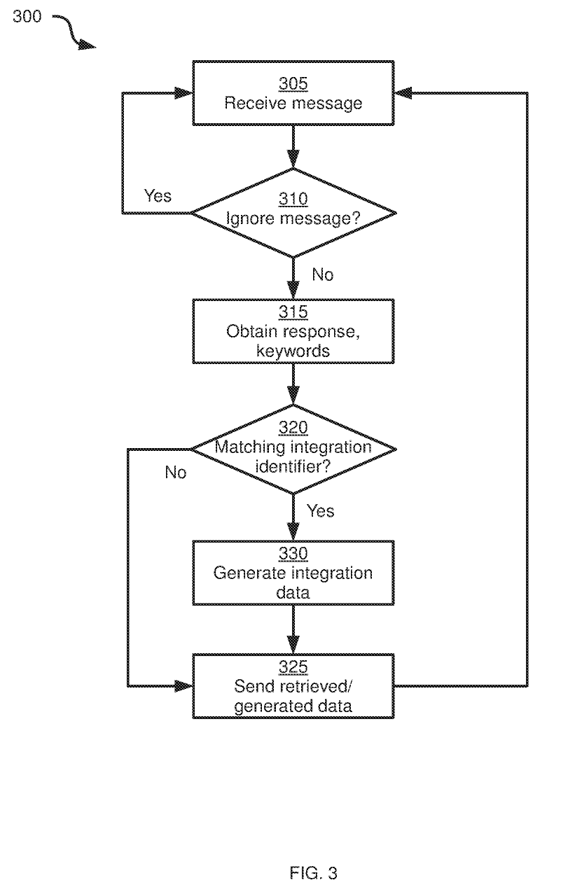

Having described certain internal components of devices 104 and servers 116 and 132, the actions performed by those computing devices will be discussed in greater detail. Referring now to FIG. 3, a method 300 of autonomous messaging integration is illustrated. Method 300 will be described below in connection with its performance in system 100. Specifically, the blocks of method 300 are performed by server 116, via the execution of application 240 by processor 230.

The example set out below illustrates a method by which server 116, in conjunction with other components of system 100, can interact with client device 104a to permit client device 104a to place an order for tickets to an event such as a movie, and supplement its own functionality with that of another chatbot to enable client device 104a to pay for those tickets. For example, application 240 may implement some or all of the functionality described in Applicant's co-pending application No. 62/297,458, filed Feb. 19, 2016 and entitled “System And Method For Integrating Messaging Network And External Service Providers”, the contents of which is incorporated herein by reference.

At block 305, server 116 is configured, via the execution of application 240, to receive a message. The received message can be stored in memory 234. It will be apparent that server 116 previously received and processed the message via the execution of application 238 and routed the message internally for processing via application 240. However, further discussion of the actions of server 116 via execution of application 238 will be deferred until a later point in this discussion.

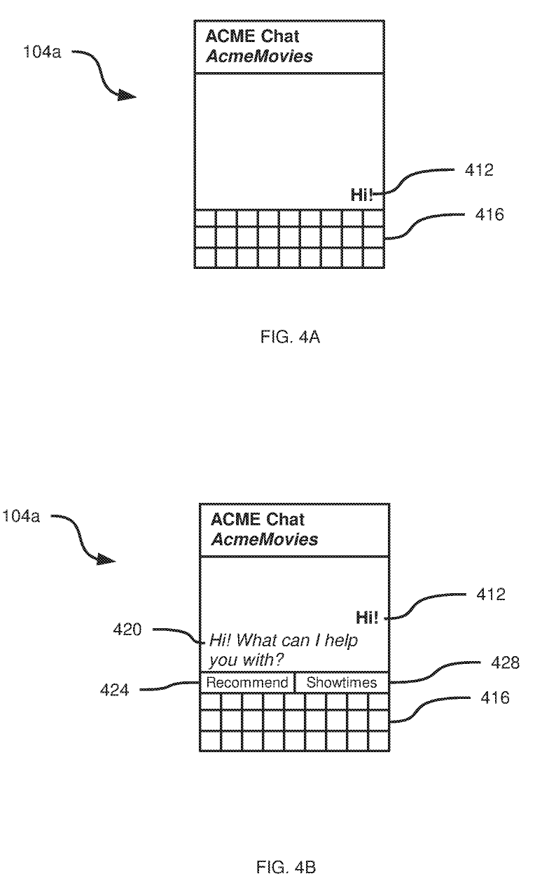

In the present example, the message is received from client device 104a. Turning briefly to FIG. 4A, client device 104a is configured to present a message composition interface on display 216 (via the execution of application 208 by processor 200). Further, client device 104a has received a message 412 composed by the operator of device 104a (e.g. via the receipt of input at a virtual keyboard 416 rendered on display 216). Following the receipt of a send command, client device 104a is configured to send the message via network 108, for delivery to server 116 (specifically, to application 240). In some embodiments, the message received at block 305 need not be explicitly composed and sent at client device 104a. For example, upon a selection of a contact record corresponding to server 116 at client device 104a, client device 104a can automatically (and invisibly to the operator thereof) send an initial message to server 116 indicating that the selection has occurred.

Returning to FIG. 3, at block 310, server 116 is configured to determine whether to ignore the received message. The determination at block 310 will be described in greater detail below. For reasons that will be apparent from subsequent discussions herein, in the present example the determination at block 310 is negative, and the performance of method 300 therefore proceeds to block 315.

At block 315, server 116 is configured to obtain response data in the form of either or both of a response body and one or more keywords. The response body and keywords are obtained based on the contents of database 246. In the present example, database 246 contains a plurality of records each defining an autonomous response to be sent to client device 104a (or any other sender of messages addressed to server 116). An example of database 246 is shown below in Table 1.

TABLE 1
Example Database 246

| Message | | Response | Integration |
|---|---|---|---|
| content | Response Body | Keywords | ID |
| [Default] | “Hi! What can I help you | Recommend; | N/A |
| | with?” | Showtimes | |
| Recommend | “What kind of movies do you | Action; | N/A |
| | like?” | Comedy; | |
| | | Horror | |
| Showtimes | “Click the link below” | N/A | N/A |
| | URL [xyz.com/showtimes] | | |
| Book | “Sure, how would you like to | Credit; | N/A |
| | pay?” | CashBot; | |
| CashBot | “@Cashbot” | N/A | 132 |

As seen above, several autonomous responses are defined in database 246. Each response record includes an indication of what client message content leads to the use of that response: a message from client device 104a containing an empty message body, or a message body that does not match any other records of Table 1 causes server 116 to reply with a default response message including the message body “Hi! What can I help you with?”. Thus, in the present example, the message shown in FIG. 4A leads to the retrieval of the first response body shown in Table 1, as the message “Hi!” does not match any other records of Table 1.

It is contemplated that although the selection of a response record in the present embodiment is based on a match between a portion of the received message and the “Message content” fields in Table 1, in other embodiments, more complex response selection processes can be implemented at server 116. For example, instead of, or in addition to, determining whether the received message matches specific content, server 116 can be configured to classify the received message to infer content not explicitly present in the message. Various message classification technologies (e.g. neural networks, Bayes classifiers) will now occur to those skilled in the art for classifying incoming messages into, for example, a “recommend” class or a “showtimes” class based on the content of the message. In some embodiments, such classification, when used alongside explicit message content matches, may be performed only when no explicit matches are detected in the message.

Each record of database 246 can also include one or more keywords that are transmitted to client device 104a with the above-mentioned message body. Keywords, in general, are suggested responses provided to client device 104a to enable client device 104a to respond quickly (e.g. with fewer keystrokes on virtual keyboard 416) to messages from server 116. In the present example, the keywords “Recommend” and “Showtimes” are stored in the selected record of database 246 (that is, the record corresponding to the body of the message received at block 305).

At block 320, server 116 is configured to determine whether the record of database 246 selected at block 315 includes an integration identifier. As seen in Table 1, each record of database 246 can also include such an integration identifier, which identifies another autonomous messaging application (i.e. chatbot). The other chatbot is typically implemented by a separate computing device, although in some embodiments it can be implemented by a separate application executed on server 116. In the present example performance of block 320, the determination is negative, because the first record of Table 1 does not contain an integration identifier. The performance of method 300 therefore proceeds to block 325.

At block 325, server 116 is configured to send the response data obtained at block 315 in a reply message to client device 104a. Thus, in the present example, at block 325 server 116 is configured to send a message to client device 104a that includes the body mentioned above, as well as the keywords ““Recommend” and “Showtimes”. The message, as will now be apparent to those skilled in the art, is routed via the execution of application 238 to client device 104a.

Turning to FIG. 4B, an example reply message is shown, having been received and displayed at client device 104a following its transmission at block 325. In particular, the reply message includes a text string 420 matching the “Response Body” of the selected record of Table 1, and selectable keywords 424 and 428, matching the keywords in the selected record of Table 1. Application 208 at client device 104 is configured to present text string 420 in a conversation window along with message 412, and to present keywords 424 and 428 as selectable elements above virtual keyboard 416. Thus, keywords 424 and 428 are selectable at client device 104a to generate additional messages to server 116.

Returning to FIG. 3, after the performance of block 325, method 300 returns to block 305 to await the receipt of a further message. As will now be apparent, a number of messages may be exchanged between server 116 and client device 104a, and processed by server 116 as described above. In the present embodiment, server 116, as noted earlier, is configured to provide client device 104a with information concerning event data (e.g. movie listings). Client device 104a, upon selecting a particular movie listing (that is, a movie, location and time), can send a message to server 116 indicating a desire to book tickets for that listing. Thus, the message may include the word “book”.

A further performance of method 300 will now be described, in which the message including the word “book” is received at block 305. Following a negative determination at block 310 (again, as will be clear from the discussion further below), server 116 is configured to obtain response data and/or keywords at block 315. As seen in Table 1, the penultimate record of database 246 is selected in the present example, including the response body “Sure, I can book tickets for you. How would you like to pay?”, and the keywords “Credit” and “CashBot”. As seen in Table 1, no integration identifier is included in the selected record, and thus method 300 proceeds to block 325, and client device 104a receives a message from server 116 that includes the selectable keyword “CashBot”.

Upon receipt of a further message from client device 104a including the word “CashBot”, at block 315 server 116 selects the final record shown in Table 1. Further, following retrieval of the above-mentioned response data, at block 320 server 116 is configured to determine whether the selected record of database 246 includes an integration identifier. In the present example, the determination is affirmative, as the selected record of database 246 includes the integration identifier “CashBot”. The performance of method 300 therefore proceeds to block 330 rather than directly to block 325.

At block 330, server 116 is configured to generate integration data. The nature of the integration data is not particularly limited, but generally includes the integration identifier from database 246, which will act as an instruction to application 238 to transmit the upcoming reply message not only to client device 104a, but also to the computing device executing the other autonomous messaging application (also referred to herein as the secondary autonomous messaging application). The integration data can also include other data retrieved from database 246 or other locations in memory 234. For example, based on previous messages exchanged with client device 104a, server 116 may have stored in memory the above-mentioned movie listing. Memory 234 may also contain a price for tickets for the movie listing, as well as a destination identifier for payments (which may even be the messaging identifier of application 240 itself, e.g. “AcmeMovies”). Any or all of the above data may be included in the integration data generated at block 330.

Following the generation of integration data at block 330, server 116 proceeds to block 325 and sends both the response data obtained at block 315 and the integration data generated at block 330. In the present example, server 116 transmits a single reply message containing both the response data and the integration data. In other examples, the response data and the integration data may be transmitted separately.

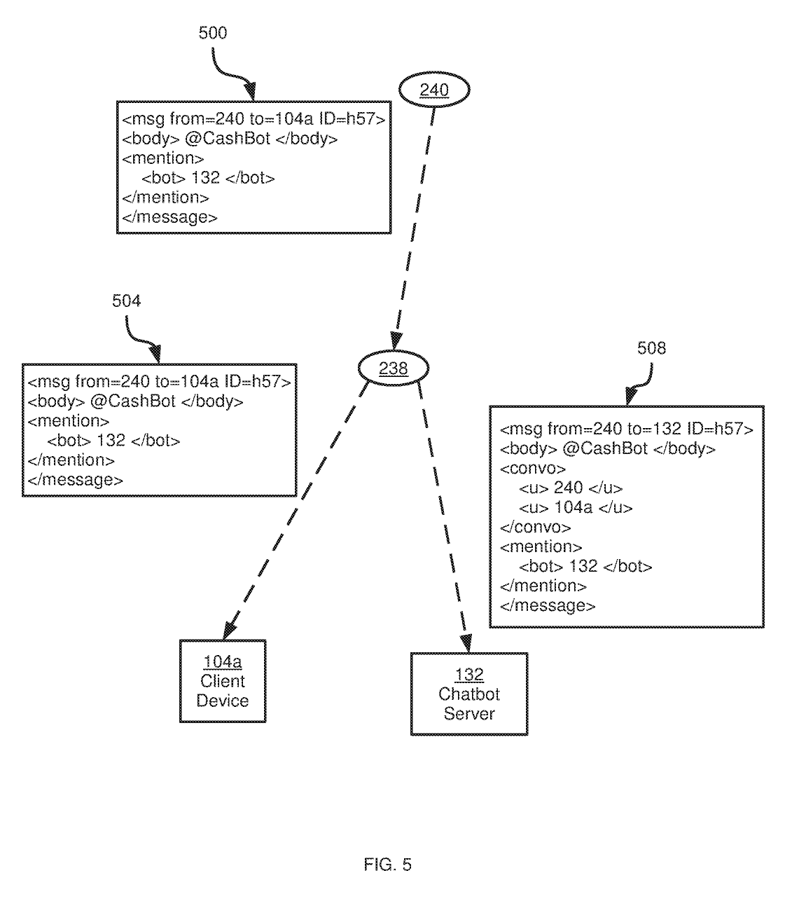

Turning to FIG. 5, a schematic representation of the transmission step at block 325 is illustrated. In particular, server 116 (via the execution of application 240) transmits a reply message 500 that includes addressing information in the form of a sender identifier (application 240) and a receiver identifier (client device 104a). Message 500 can also include a message identifier (“h57”), in some embodiments. Message 500 includes the response data retrieved at block 315, in the form of a body data element containing the string “@CashBot”. In addition, message 500 includes integration data in the form of a “mention” data element containing the integration identifier retrieved at block 330.

Upon receipt of message 500 for routing, server 116 is configured (via the execution of application 238) to generate two outgoing messages. One outgoing message 504 is routed conventionally to client device 104a, for presentation on display 216. Another outgoing message 508, however, is also generated as a result of the inclusion of integration data in message 500. Message 508 contains the same message identifier and body as messages 500 and 504, but is addressed to server 132 instead of client device 104a. In addition, message 508 includes additional integration data, for example in the form of a “convo” data element indicating the parties to the conversation from which message 508 originated.

Although the generation of messages 504 and 508 from message 500 is illustrated in FIG. 5 as taking place at server 116 via the execution of application 238, in other embodiments, application 240 itself can cause server 116 to send messages 504 and 508. In other words, the generation of messages 504 and 508 need not be a routing activity in other embodiments.

Thus, as will now be apparent, through the use of integration identifiers in database 246, server 116 is configured to automatically initiate communications with other chatbots in response to certain messages from client devices 104. As will be discussed below, such initiation permits client device 104a to interact with both server 116 and server 132, in a common (i.e. integrated) conversation interface presented on display 216.

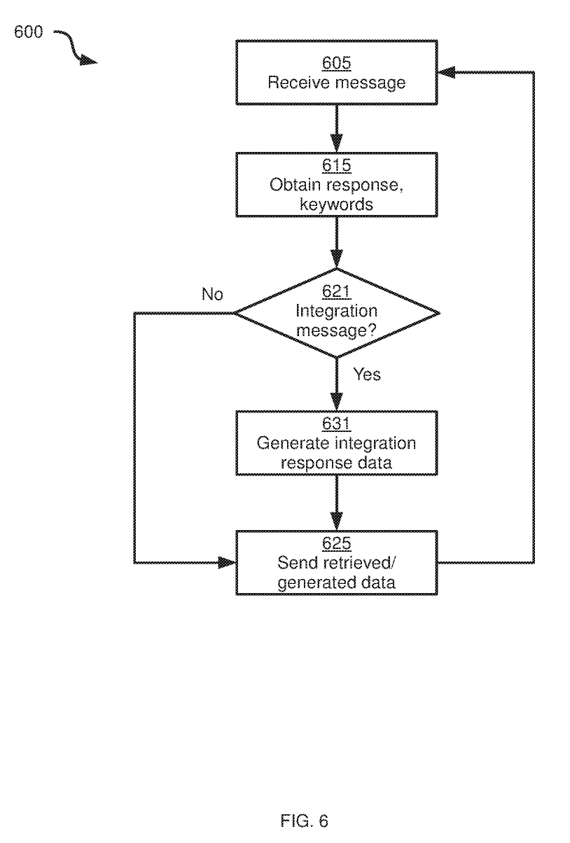

Turning now to FIG. 6, a method 600 of autonomous messaging integration performed at server 132 is illustrated. More specifically, method 600 is performed by server 132 via the execution of application 270. At block 605, server 132 is configured to receive a message. The performance of block 605 is as described above in connection with block 305. In the present example, the message received at block 605 is message 508, shown in FIG. 5.

Following receipt of the message at block 605, server 132 can be configured to perform a determination similar to that of block 310 of method 300. However, in the present example performance of method 600, the determination as to whether or not to ignore the message is omitted for simplicity. Therefore, server 132 proceeds directly to block 615.

At block 615, server 132 is configured to obtain response data in the form of either or both of a response body and one or more keywords, as described above in connection with block 315. The response body and keywords are obtained based on the contents of database 276. In the present example, database 276 contains a plurality of records each defining an autonomous response to be sent in reply to the message received at block 605. An example of database 276 is shown below in Table 2.

TABLE 2
Example Database 276

| Message | | Response |
|---|---|---|
| content | Response Body | Keywords |
| [Default] | “CashBot here, how can I help?” | Send Money; |
| | | Balance |
| Balance | “Your current balance is” [insert | N/A |
| | balance] | |
| Send Money | “Send money to which ID?” | N/A |
| [Payee ID] | “How much would you like to send?” | N/A |

As seen in Table 2, database 276 includes a plurality of response records, each including message content that leads to the selection of that record for responding to the message. Each record also includes a response body, and may include one or more keywords. As will be apparent, the records shown in Table 2 are provided for example only, and a wide variety of other response records may be included instead of, or in addition to, those shown above. In general, application 270 enables server 132 to process payments to other users of the messaging server provided by server 116 in response to messages from client devices 104. For example, server 132 can implement at least a portion of the functionality of the synchronization server described in Applicant's co-pending application No. 62/291,831, filed Feb. 5, 2016 and entitled, “System And Method For Accelerating Processing Of Electronic Transactions”, the contents of which is incorporated herein by reference.

Although not illustrated in Table 2, database 276 can also include integration identifiers (i.e. for calling additional chatbots). Further, some records of database 276 can include data for causing server 132 to transmit data to external computing devices, such as financial servers.

At block 621, server 132 is configured to determine whether the message received at block 605 is an integration message. In particular, server 132 is configured to examine the received message to determine whether the message includes integration data, such as the “mention” data element shown in FIG. 5. When the determination is negative, server 132 is configured to send the response data obtained at block 615. When the determination at block 621 is affirmative, however (as in the present example), server 132 is configured to proceed to block 631.

At block 631, server 132 is configured to generate integration response data. The integration response data, in general, acts as an instruction to server 116 (specifically, to application 238) to transmit server 132's reply message to not only the sender of the message received at block 605, but also to any other parties to the conversation from which that message originated. Thus, server 132, in the present example, is configured to generate integration response data including an addressing element that identifies server 116 (more specifically, application 240, also referred to as the primary chatbot) and client device 104a.

At block 625, server 132 is configured to transmit the data obtained at block 615, as well as any data generated at block 631. In the present example, a single reply message is sent at block 625, including both the integration response data and the response data from block 615. However, in other embodiments, the response data and integration response data may be sent as separate messages.

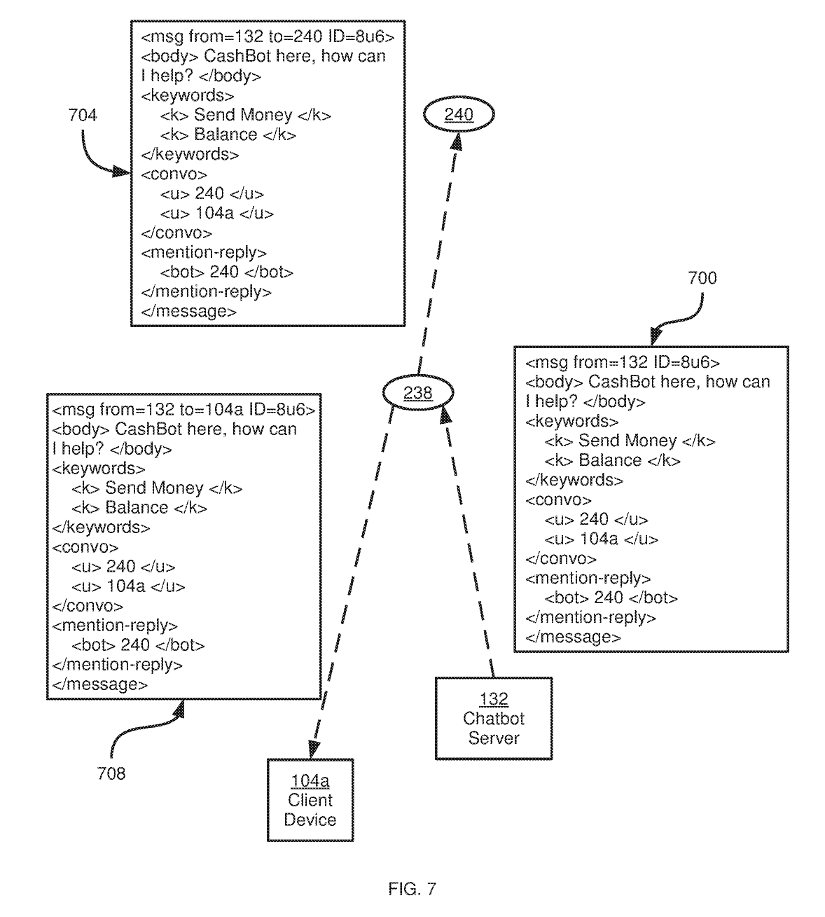

Turning now to FIG. 7, an example implementation of block 625 is shown, following a performance of block 631. In particular, server 132 is configured to send a message 700 including the response data retrieved from Table 2 in the “body” and “keywords” element thereof. Message 700 also includes a “from” element and a message identifier that is distinct from the message identifiers shown in FIG. 5. However, in the present example, message 700 does not include a “to” element. Instead, addressing of message 700 is achieved by the integration response data, which includes the “convo” element shown in FIG. 5. The integration response data can also include a “mention-reply” element identifying the originator of the integration message received at block 605 (in the present example, application 240 or “AcmeMovies”).

Following receipt of message 700, server 116, via the execution of application 238, transmits a message to each of application 240 and client device 104a. Specifically, a message 704 is sent to application 240, and a message 708 is sent to client device 104a. Messages 704 and 708 include the above-mentioned response data and integration response data.

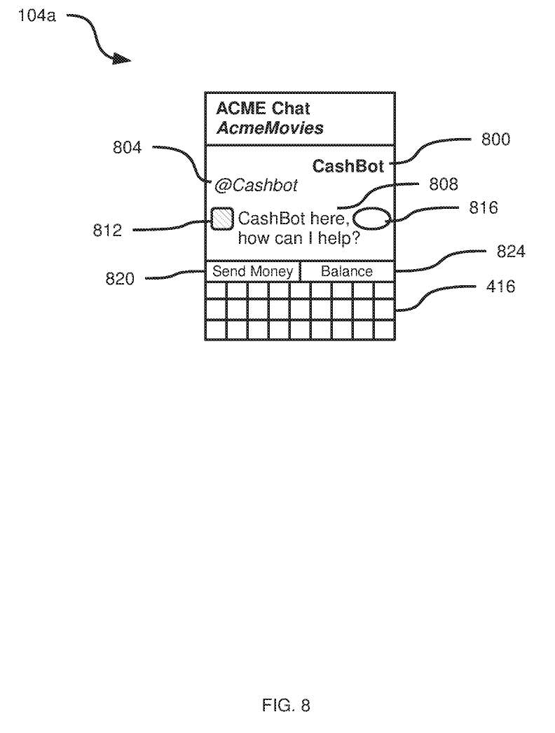

Turning now to FIG. 8, a conversation is presented on display 216 of client device 104a, including a message 800 sent earlier by client device 104a, and the response 804 from server 116 that led to the transmission of message 504 to server 132. In addition, a message 808 is shown, corresponding to message 708 as shown in FIG. 7. As will now be apparent, application 208 is configured to detect integration response data, and to display message 808 in the conversation identified by that integration response data, rather than as a separate conversation between client device 104a and server 132.

Message 808 can be distinguished from messages received at client device 104a from server 116 (e.g. message 804) by a graphic 812, such as an avatar associated with server 132. In addition, application 208 can be configured to present a selectable reply element 816 alongside message 808. Subsequent messages composed at client device 104a may be marked as further integration messages by either selecting reply element 816 or entering the identifier of server 132 (e.g. “CashBot” or “132”), preceded by a character such as “@”. Application 208 can be configured to detect such data in a message, and in response insert integration data to a message being transmitted to server 116. For example, client device 104a can be configured to insert a “mention” element as shown in FIG. 5 to indicate that a message is intended for server 132, and to omit such an element when a message is intended for server 116.

As will now be apparent, subsequent messages from client device 104a can be processed via the execution of method 300 at server 116, and, under certain conditions (as specified in database 246 or in integration data inserted by client device 104a), via the execution of method 600 at server 132. Returning to FIG. 3, the determination at block 310 will now be discussed briefly. Upon receipt of a message (e.g. from client device 104a) at block 305, server 116 is configured to determine whether the message includes integration data in the form of a “mention” data element identifying another chatbot, or a “mention-reply” data element. When the message does include such data, server 116 is configured to ignore the message and return to block 305. In other words, integration data in a message received at block 305 indicates that the message either originates from client device 104a and is directed to a different chatbot (e.g. server 132), or originates from another chatbot and will be responded to by client device 104a.

In the above example performances of methods 300 and 600, server 116 initiates the integration of functionality made available to client device 104a by two distinct chatbots. As will now be apparent, a wide variety of chatbot-enabled functionality can be integrated. For example, the above-mentioned ticket booking service provided by server 116 can be integrated with a taxicab or ride-sharing service (e.g. enabling client device 104a to order a taxi to the event via a further chatbot).

It is contemplated that methods 300 and 600 can both be performed by each of the above-mentioned chatbots. In other words, both servers 116 and 132 can act as primary and secondary chatbots.

Variations to the above embodiments are contemplated. For example, although in the above examples, server 116 is configured to ignore messages from server 132 following the integration of server 132 into a conversation between server 116 and client device 104a, in other embodiments, server 132 can include an indication (e.g. in message 708) as to which of the conversation participants is expected to respond to the message. Thus, under certain circumstances, servers 116 and 132 can communicate directly with each other (with the messages exchanged between servers 116 and 132 also appearing on display 216 of client device 104a).

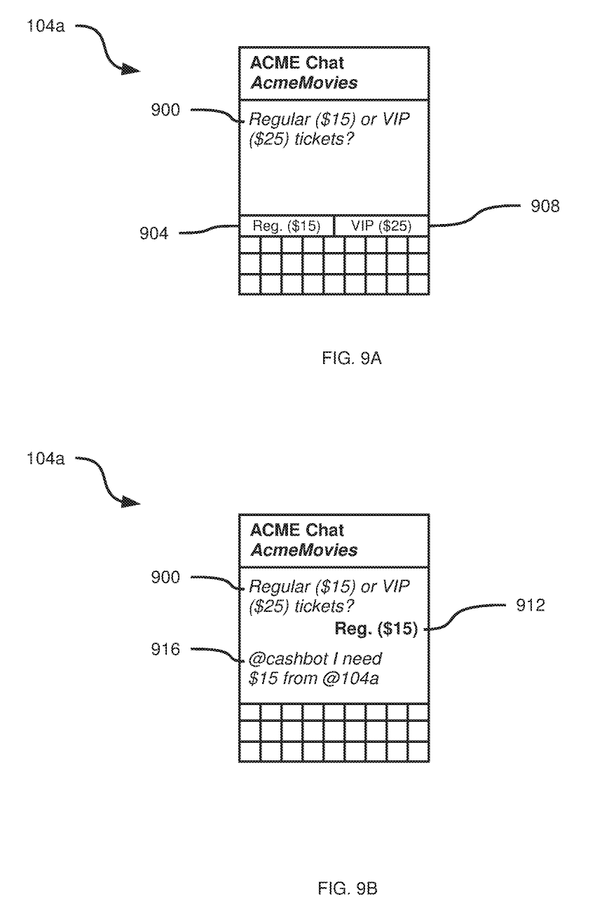

In further variations, as mentioned above, the integration data transmitted at block 325 can include identifiers of payer or payee entities, as well as payment amounts. Referring to FIG. 9A, another embodiment is shown in which a message 900 is transmitted to device 104a at block 325, including two selectable keywords 904 and 908 each corresponding to a different level of tickets to the event mentioned earlier (e.g. a movie). Upon selection of a keyword, client device 104a is configured to send a message 912 shown in FIG. 9B. Message 912 is received at server 116 via another performance of block 305. In this example embodiment, database 246 can include a record such as that shown in Table 3 below:

TABLE 3
Example Database 246

| Message | | Response | Integration |
|---|---|---|---|
| content | Response Body | Keywords | ID |
| . . . | . . . | . . . | . . . |
| Reg. [amount] | “@cashbot I need [amount] | N/A | 132 |
| | from @[client]” | | |

As seen above, upon receipt of message 912, server 116 is configured to generate both response data and integration data (as described earlier) directing a message to both client device 104a and server 132, and including payer (client device 104a, in this example) and payee (“I”, corresponding to server 116 itself) identifiers as well as an amount. The payer and payee identifiers and the amount can also be included in portions of the message other than the message body, in some embodiments. The result of another performance of block 325 is shown in FIG. 9B with a message 916.

Following transmission of message 916 (which is routed to server 132 as described above), server 132 can be configured, via performance of method 600, to select and send a response to message 916. In the present embodiment, database 276 may include a record as shown below in Table 4.

TABLE 4
Example Database 276

| Message | | Response |
|---|---|---|
| content | Response Body | Keywords |
| . . . | . . . | . . . |
| [Payee ID] + [Payer | “@[Payee ID], OK to pay [Amount] to | Approved; |
| ID] + [Amount] | [Payee ID]?” | Canceled |

As seen above, server 132 can be configured, responsive to a message with payer and payee identifiers and an amount, to request confirmation from the payer identifier (client device 104a, in this case) that the transfer should be effected. As will now be apparent, server 132 is configured to detect various strings in incoming messages as payer or payee identifiers, or as amounts. In other embodiments, the identifiers and amounts can be carried outside the message body, such as in the “mention” tags described above.

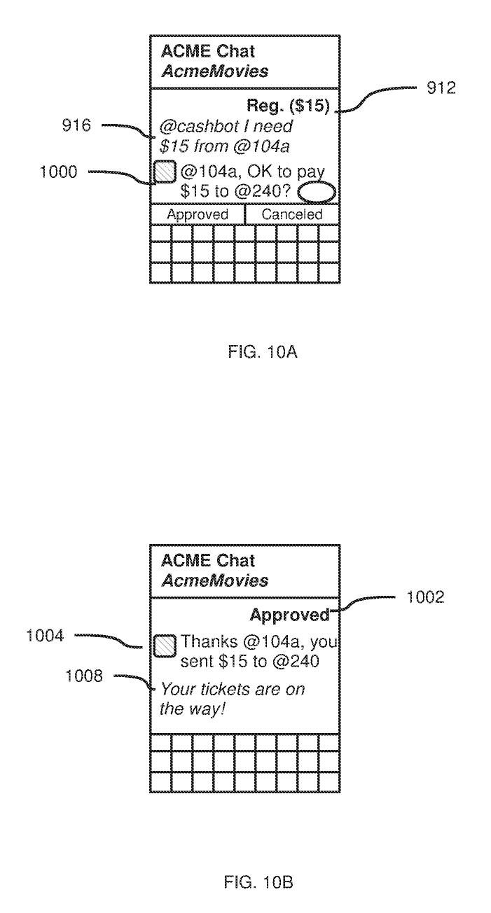

Turning to FIG. 10A, responsive to message 916, server 132 is configured to generate and transmit a message 1000 including selectable response keywords permitting client device 104a to approve or cancel the transfer of funds from client device 104a to server 116. Responsive to selection of the “Approved” keyword by client device 104a (illustrated by a message 1002 transmitted by client device 104a), server 132 can, via performance of method 600, transmit a reply 1004 confirming that the transfer is complete. As will now be apparent, server 132 can also interact with other computing devices (not shown) in order to actually effect the transfer.

Server 116 can be configured to detect message 1004, or receipt of the above-mentioned transfer, and transmit a further message 1008 to client device 104a confirming that the now-purchased tickets will be available soon. The detection mentioned above can be based on further records in database 246, which can configured server 132 to respond to specific strings in message 1004, or to data contained in message 1004 other than the message body (such as an additional field in the “mention” tags described earlier).

Client device 104a can also initiate the integration of a chatbot in a conversation with server 116, server 132, or another client device 104, via the mechanisms described above.

The scope of the claims should not be limited by the embodiments set forth in the above examples, but should be given the broadest interpretation consistent with the description as a whole.

1. A method of autonomous messaging integration at a computing device executing a primary autonomous messaging application, comprising:
receiving a message from a client device;
responsive to receiving the message, obtaining response data corresponding to the message;
determining whether the message corresponds to an integration identifier stored in the memory, the integration identifier identifying a second computing device executing a secondary autonomous messaging application;
when the determination is affirmative:
generating integration data including the integration identifier; and
sending a reply containing (i) the response data, (ii) a destination identifier corresponding to the client device, instructing a routing server to transmit the reply to the client device, and (iii) the integration data, instructing the routing server to transmit the reply to the second computing device.

2. The method of claim 1, wherein obtaining the response data comprises selecting one of a plurality of response data records in the memory based on the message received from the client device; the response data record containing keywords selectable at the client device following transmission of the reply to the client device.

3. The method of claim 2, wherein determining whether the message corresponds to an integration identifier comprises determining whether the selected response data record contains an integration identifier.

4. The method of claim 1, the reply including a body element comprising the response data, an addressing element containing the destination identifier, and an integration element containing the integration data.

5. The method of claim 4, wherein the integration data includes an identifier of the second computing device.

6. The method of claim 5, wherein the addressing element does not contain the identifier of the second computing device.

7. A method of autonomous messaging integration at a computing device executing a secondary autonomous messaging application, comprising:
receiving a message addressed to the computing device and containing a sender identifier corresponding to a primary computing device executing a primary autonomous messaging application;
responsive to receiving the message, obtaining response data corresponding to the message;
determining whether the message includes integration data identifying the computing device and a client device;
when the determination is affirmative:
generating integration response data, including an integration addressing element identifying the primary computing device and the client device; and
sending an integration reply containing (i) the response data and (ii) the integration response data, instructing a routing server to transmit the integration reply to the primary computing device and the client device.

8. The method of claim 7, the integration response data including an additional integration element containing an identifier of the computing device.

9. The method of claim 7, wherein obtaining the response data comprises selecting one of a plurality of response data records in the memory based on the received message; the response data record containing keywords selectable at the client device following transmission of the integration reply to the client device.

10. The method of claim 7, the integration reply further including a main addressing element containing an identifier of the computing device.

11. The method of claim 10, wherein the main addressing element does not contain a recipient identifier.

12. A method of autonomous messaging integration at a client device, the method comprising:
rendering, on a display of the client device, a message thread between the client device and a primary computing device executing a primary autonomous messaging application;
receiving a message addressed to the client device from a secondary computing device;
determining whether the message contains integration data identifying the primary computing device; and
when the determination is affirmative, rendering the message on the display with the message thread between the client device and the primary computing device.

13. The method of claim 12, further comprising:
rendering on the display, in association with the message, a graphic distinguishing the message from other messages in the message thread.

14. The method of claim 12, further comprising:
rendering on the display, in association with the message, a selectable reply element.

15. The method of claim 14, further comprising, responsive to a selection of the reply element:
obtaining response data;
generating a reply message containing the response data and an integration element identifying the secondary computing device.

16. The method of claim 15, wherein obtaining response data comprises rendering keywords contained in the message on the display, and receiving a selection of one of the keywords.

17. The method of claim 14, further comprising:
obtaining response data, absent a selection of the reply element; and
generating a reply message containing the response data and an integration element identifying the primary computing device.
